(19) United States
(12) Patent Application Publication
(10) Pub. No.: US 2012/0139954 A1
(43) Pub. Date: Jun. 7, 2012

(54) ELECTRONIC DEVICE, DISPLAY CONTROL METHOD AND STORAGE MEDIUM FOR DISPLAYING A PLURALITY OF LINES OF CHARACTER STRINGS

(75) Inventor: Takeo OZAWA, Akishima-shi (JP)

(73) Assignee: CASIO COMPUTER CO., LTD., Tokyo (JP)

(21) Appl. No.: 13/307,135

(22) Filed: Nov. 30, 2011

(30) Foreign Application Priority Data
Dec. 1, 2010 (JP) 2010-268341

(51) Int. Cl. G09G 5/00

(52) U.S. Cl. 345/685

(57) ABSTRACT

An electronic device includes: a display section that displays a plurality of lines of character strings on a screen; a character string specifying section that specifies one of the character strings displayed on the screen; and a display control section that scroll-displays the one of the character strings specified by the character string specified section based on a reading direction of the one of the character strings, in which character information is scroll-displayed in a predetermined direction according to the reading direction of the character string displayed on each line.

### CROSS-REFERENCE TO RELATED APPLICATION

This application claims the benefit of Japanese Patent Application No. 2010-268341, filed on Dec. 1, 2010, the entire disclosure of which is incorporated by referring to the specification, claims and drawings thereof herein.

### FIELD

This application relates to an electronic device that scroll-displays character information in a predetermined direction according to a chosen language and includes a print device printing multilingual character strings simultaneously to produce printed material, a display method to display character information according to the language in the electronic device, and a storage medium to make the electronic device realize the display method to display character information according to the language.

### BACKGROUND

Presently, there is an electronic device that includes a print device to produce unique labels in such a way that a tape cassette housing a tape member is set into the device, and characters inputted from an input means such as a keyboard or outputted from another device are printed on the print tape of the tape member.

The application of labels produced with an electronic device including such a print device has been expanded. As a result, in consideration of the application of labels, such a print device employs various types of printing and various processing during printing, which are not employed in other print devices.

For example, in public places such as railways and tourist spots where many people come and go, labels printing signs have been used in order to show locations of toilets, emergency exits and so on.

Then, in producing labels to be used in public places, proposed is a print device that can print in one language as well as in a foreign language so that foreigners can understand the printed content.

In producing labels; however, a liquid crystal panel of the label production device often has a small display range and, therefore, it is necessary to scroll-display characters on the label to be produced sideways thereby to check the entire text of the label. In addition, some multi-language labels may be produced in languages such as Japanese and English that are read from left to right, some multilingual labels may be produced in languages such as Arabic that are read from right to left, and some multilingual labels may be produced with both languages that are read from left to right and from right to left.

For this reason, Unexamined Japanese Patent Application KOKAI Publication No. 2008-40351 (hereinafter referred to as “Patent Document”) discloses an information processor that enables character strings and icons to be suitably laid out on a screen according to a plurality of languages whose character strings have different writing directions.

Although the information processor of the above Patent Document automatically enables character strings and icons to be suitably laid out on a screen according to a plurality of languages whose character strings have different writing directions, it does not enable the whole text to be easily checked while scrolling the long character string in a predetermined direction according to the language.

### SUMMARY

The present invention has been made in view of the above problem of the conventional art, and intends to provide an electronic device that scroll-displays character information in a predetermined direction according to the chosen language and includes a print device printing multilingual character strings simultaneously to produce printed material, a display method to scroll-display character information in a predetermined direction according to the language in the electronic device, and a storage medium to make the electronic device realize the display method to scroll-display character information in a predetermined direction according to the language.

In order to achieve the above intention, the electronic device according to the present invention has a display section that displays a plurality of lines of character strings on a screen, a character string specifying section that specifies one of the character strings displayed on the screen, and a display control section that scroll-displays the one of the character strings specified by the character string specified section based on a reading direction of the one of the character strings.

In order to achieve the above intention, the display control method according to the present invention performs display processing that displays a plurality of lines of character strings on a screen, character string specifying processing that specifies one of the character string out of the plurality of character strings displayed on the screen, and display control processing that scroll-displays the one of the character strings specified by the character string specifying section based on a reading direction of the one of the character strings.

In order to achieve the above intention, the non-transitory computer-readable storage medium according to the present invention stores an executable program makes a computer perform display processing that displays a plurality of lines of character strings on a screen, character string specifying processing that specifies a character string, out of the plurality of character strings displayed on the screen, and display control processing that scroll-displays the one of the character strings specified by the character string specifying section based on a reading direction of the one of the character strings.

The present invention can provide a print device that scroll-displays character information in a predetermined direction according to the chosen language and prints multilingual character strings simultaneously to produce printed material, a display method to scroll-display character information in a predetermined direction according to the language in the print device, and a non-transitory computer-readable storage medium stores an executable program to make the print device realize the display method to scroll-display character information in a predetermined direction according to the language.

### BRIEF DESCRIPTION OF THE DRAWINGS

A more complete understanding of this application can be obtained when the following detailed description is considered in conjunction with the following drawings, in which:

FIG. 1 is a plan view of an electronic device according to the embodiment of the present invention;

FIG. 2 is an enlarged view of the inside of an electronic device and a perspective view of a tape cassette according to the embodiment of the present invention;

FIG. 3 is a block diagram of an electronic device according to the embodiment of the present invention;

FIG. 4 is a flow chart illustrating the flow of a method to display data composed of a plurality of character strings according to the embodiment of the present invention;

FIG. 5A, FIG. 5B and FIG. 5C are illustrations showing a method to display data composed of a plurality of character strings according to the embodiment of the present invention;

FIG. 6A, FIG. 6B and FIG. 6C are illustrations showing a method to display data composed of a plurality of character strings according to the embodiment of the present invention;

FIG. 7 is an illustration of a label composed of a plurality of character strings according to the embodiment of the present invention;

FIG. 8A, FIG. 8B and FIG. 8C are illustrations showing a method to display data composed of a plurality of character strings according to the embodiment of the present invention; and

FIG. 9A, FIG. 9B, FIG. 9C, FIG. 9D and FIG. 9E are illustrations showing a method to display data composed of a plurality of character strings according to another embodiment of the present invention.

### DETAILED DESCRIPTION

### Embodiment

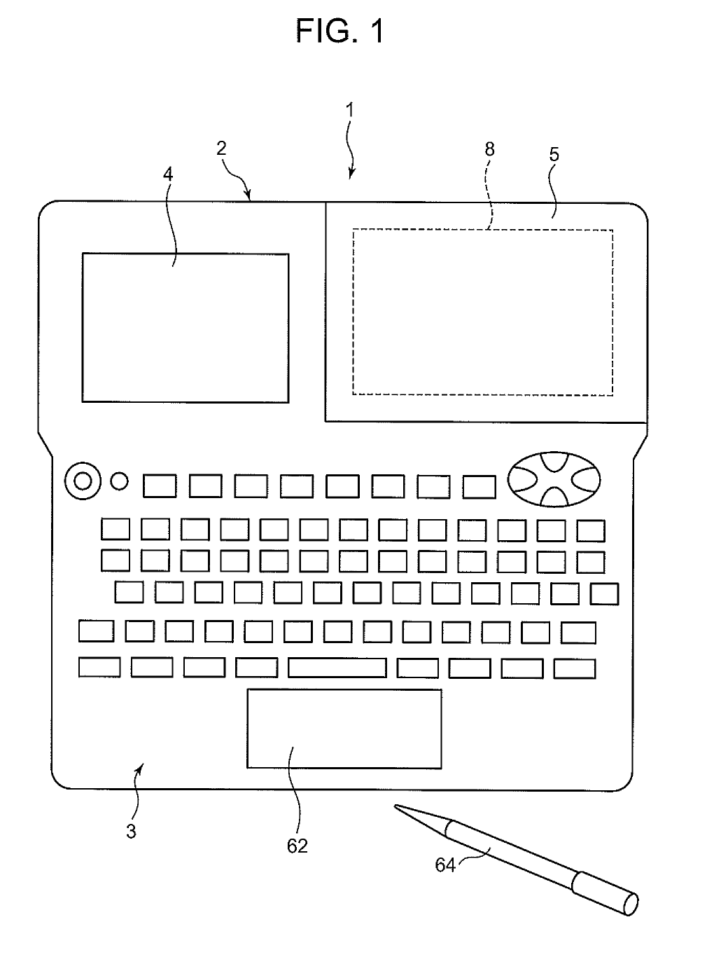

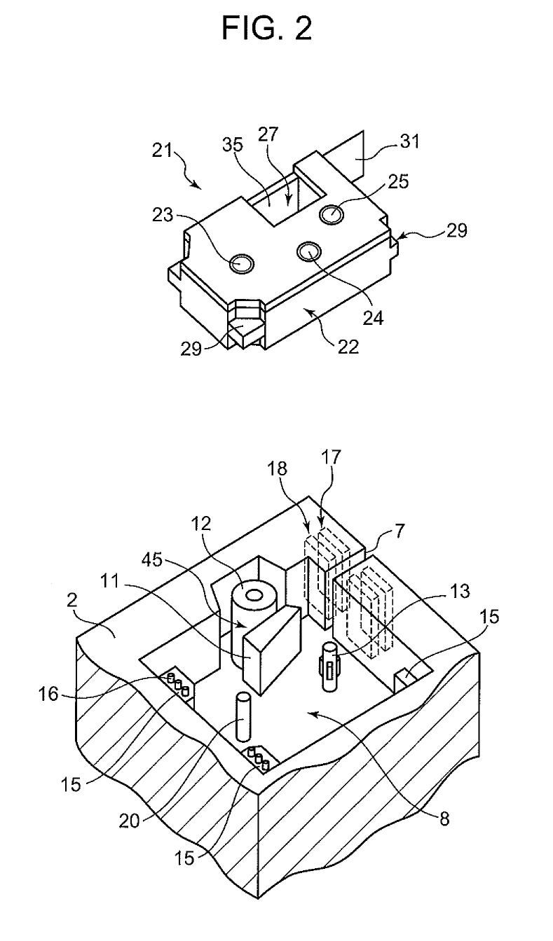

An embodiment of the present invention will be described in detail with reference to drawings. FIG. 1 a plan view of an electronic device 1 including a print device according to the embodiment of the present invention, and FIG. 2 is a perspective view illustrating the appearance of a tape cassette 21 used for the print device included in the electronic device 1 and part of the inside structure of the print device. The print device included in the electronic device 1 is a print device that prints characters and so on onto a tape member 31 formed by laminating a print tape of which the front face is a print face and the back face is an adhesive face and a release tape attached to the adhesive face.

In this electronic device 1, the upper surface of a housing 2 is provided with a keyboard input section 3, a display section 4, and an opening/closing cover 5 to cover a cassette loading section 8, as illustrated in FIG. 1. The housing 2 is also provided with an input terminal for connecting to an external device such as a personal computer, a power terminal to which a power code is connected, and a loading slot to which a storage medium such as a memory card is loaded, although they are not illustrated.

The keyboard input section 3 is composed of character input keys to input character data, a print key to instruct the start of printing, a cursor key to operate the movement of the cursor on a display screen of the display section 4, and various control keys to set a print mode and various setting processing. The display section 4 is a panel such as a liquid crystal display panel as the main panel in the electronic device 1, and displays an image of inputted data, a selection menu for various setting, a message about various processing, and so on.

The electronic device 1 includes a touch panel display section 62 as a sub panel that is a display means of the present invention. The electronic device 1 has a touch pen 64 so that a screen position can be specified by a touch on the touch panel display section 62.

The touch panel display section 62 is a display panel that is an integrated panel of a touch panel as a screen position specifying means and a liquid crystal display panel as a display device, and input can be performed through the touch panel display section 62.

Since the touch panel display section 62 is a compact liquid crystal display panel as illustrated in FIG. 1, an entire text may not be displayed on the panel if a long text label is produced.

Accordingly, when a long character string beyond the display screen area is displayed, the touch panel display section 62 scroll-displays the character string in the direction according to the reading direction of its language so that the character string moves outside the panel in sequence.

The display section 4 may be a touch panel similar to a sub panel that has both screen positions specifying function by a touch on the screen and display function.

Inside the opening/closing cover 5, a cassette loading section 8 is formed for loading the tape cassette 21 that houses a tape member 31 and an ink ribbon 35, as illustrated in FIG. 2. Inside the cassette loading section 8, a tape print mechanism 45, and a cassette receiving section 15 to support the tape cassette 21 in a predetermined position are formed.

This tape print mechanism 45 includes printing elements longitudinally arranged, a thermal head 11 as a print head, a platen roller 12 that conveys the tape member 31 and ink ribbon 35 while holding the tape member 31 and ink ribbon 35 between the platen roller 12 and the thermal head 11, and a ribbon take-up shaft 13 to take the used ink ribbon 35 up into the tape cassette 21.

At one end of the cassette loading section 8, a tape delivery section 7 leading to the outside of the housing 2 is formed, and into this tape delivery section 7 a full-cut mechanism 17 as a full-cut means to cut the print tape and release tape as the tape member 31 in the direction of the width and a half-cut mechanism 18 as a half-cut means to cut only the print tape of the tape member 31 are integrated.

Furthermore, the tape cassette 21 includes a cassette case 22, and inside the cassette case 22 are housed a tape core 23 on which the tape member 31 is wound, a ribbon supply core 24 on which an unused ink ribbon 35 is wound, and a ribbon take-up core 25 to take the used ink ribbon 35 up. In the cassette case 22 of the tape cassette 21, a head placement section 27 where the thermal head 11 is placed when the tape cassette 21 is loaded into the cassette loading section 8 is also formed.

At the corners of the cassette case 22, engaged sections 29 that engage with the cassette receiving section 15 of the cassette loading section 8 and are supported by the cassette receiving section 15 are formed. The engaged section 29 of the cassette case 22 has predetermined concave and convex portions, which are not illustrated, formed according to the type of the tape cassette 21. The cassette receiving section 15 of the cassette loading section 8 has a predetermined tape width detection switch 16 to determine the concave and convex portions formed on the engaged section 29 of the cassette case 22 when the tape cassette 21 is loaded.

In the electronic device 1, when the cassette case 22 is loaded to the cassette loading section 8, the engaged section 29 of the cassette case 22 engages with some or all of the tape width detection switches 16 formed on the cassette receiving section 15 of the cassette loading section 8 and thus the engaged tape width detection switches 16 are pressed to the position of being ON. By a combination of the ON-state tape width detection switches 16, the type of the tape cassette 21 such as the tape width can be determined.

That is, in the print device mounted on the electronic device 1, the type of the tape cassette 21 depends on the width and so on of the tape member 31 housed in the tape cassette 21. Therefore, by determining the type of the tape cassette 21, the width, color and so on of the material to be printed can be identified, thereby enabling the control section 40 to produce print data suitable to the tape width.

In this print device of the electronic device 1, when printing is instructed, the tape member 31 and ink ribbon 35 are drawn out of the tape cassette 21 and held and conveyed between the platen roller 12 and the thermal head 11 with the tape member 31 and ink ribbon 35 being layered.

Then, the thermal head 11 is thermal-driven on the basis of print data, and ink of the ink ribbon 35 is thermal-transferred to the print tape of the tape member 31 so that printing is performed to the print tape. After completion of printing, the full-cut mechanism 17 or the half-cut mechanism 18 is activated depending on the setting to cut the tape member 31 in the direction of its width, thereby producing a piece of tape-shaped label.

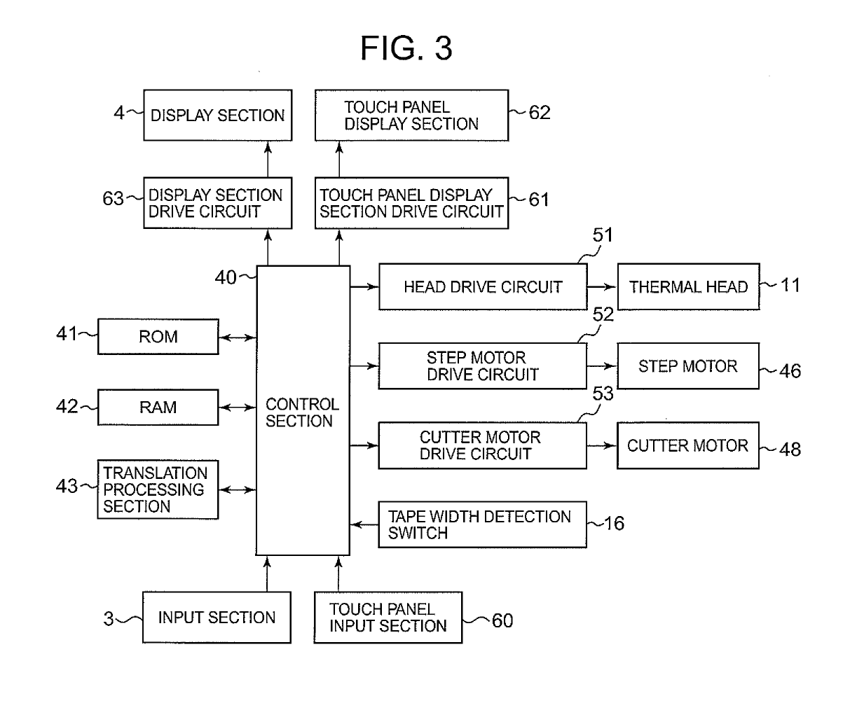

FIG. 3 is a block diagram illustrating a circuit configuration of the electronic device 1. The electronic device 1 includes the control section 40 that is a means to control the entire system, as well as a screen position detection means and a print data generation means, as illustrated in FIG. 3.

To the control section 40, a ROM 41 and a RAM 42 as a storage means, the keyboard input section 3 as an input means, and a touch panel input section 60 are connected. When a screen position specification input is performed by a touch on the touch panel input section 60 with the touch pen 64, the control section 40, as the screen position detection means, detects coordinate data representing the inputted screen position.

To the control section 40, a display section drive circuit 63 to drive the display section 4, and a touch panel display section drive circuit 61 as a display control means that drives the touch panel display section 62 are also connected.

The touch panel display section drive circuit 61 drives the touch panel display section 62 as a display means by an instruction from the control section 40.

For example, when the touch panel display section drive circuit 61 controls the touch panel display section 62 to display a long text character string, it scroll-displays the character string in the direction according to the reading direction of its language so that the character string moves out of the panel in sequence. Specifically, in displaying a long-text character string, if the character string is Japanese, English, Chinese or Korean character string data, the touch panel display section drive circuit 61 scroll-displays the character string leftward since these languages are read from left to right, and if the character string is Arabic, Hebrew or Persian character string data, the touch panel display section drive circuit 61 scroll-displays the character string rightward since these languages are read from right to left.

The print device 1 has a multi-language label production mode in producing labels of a plurality of lines of character strings. In the multi-language label production mode, when a user sets the number of lines, a language for each line, and a character string (for example “hello” in Japanese) for each line, a character string representing “hello” in each language is set for each line, and data of a plurality of lines of character strings are previewed on the touch panel display section 62 and so on. Then, by the user's pressing of the print key, printing is started.

When in the multi-language label production mode each setting is performed, the control section 40 stores a language set for each line in the RAM 42 as the language setting section. When a language is set, the reading direction information for each line as well as the language are stored in the RAM 42 as the language setting section since the reading direction information of the set language has been previously stored in a table memory in the ROM 41. In addition, the control section 40 stores data of a plurality of lines of character strings in the RAM 42 as a character string data storage means. If the user has specified a translation mode, the control section 40, in producing character string data for each line, can activate a translation processing section 43 that includes a dictionary function corresponding to the language set by the language setting section, on the basis of character string data of the line inputted first, to perform translation, automatically produce character string data of another line, and store the data in the RAM 42 as a character string data storage means.

Then, if print processing is performed, the control section 40, as a print data generation means, generates print pattern data on the basis of character string data stored in the character string data storage section of the RAM 42.

While data of a plurality of lines of character strings are previewed, if the control section 40 detects a touch on the screen, the control section 40 detects the selected line from the detected coordinate data, and detects the selected language out of language data for each line previously stored in the language storage section of the RAM 42. Then, the control section 40 controls the touch panel display section drive circuit 61 to function as a direction control means to scroll-display in the reading direction based on the selected language.

To the control section 40, a head drive circuit 51, a step motor drive circuit 52 and a cutter motor drive circuit 53 to drive various mechanisms are also connected.

The control section 40 is a CPU and, in response to a key operation signal from the keyboard input section 3 and touch panel input section 60, or automatically, activates a system program previously stored in the ROM 41, a control program stored in a memory card, the control program read from an external device, or the like to control operation of each section of the circuit with the use of the RAM 42 as a work memory.

The ROM 41 stores a program for printing characters inputted from the keyboard input section 3 or the touch panel input section 60, a display control program to realize a display method according to the present invention, and functions as a storage medium to store the program that can be read by the control section 40.

The RAM 42 has respective areas such as an input data memory as a character string data storage means that stores data of a plurality of lines of character strings by input information inputted by a key or a touch pen, a print data memory to store print pattern data expanded from the inputted print information, each-line language data memory as a language setting section, and a display data memory to store pattern data to be displayed on the display section 4 or the touch panel display section 62 and has a register and a counter to temporarily store data necessary for print processing and so on.

The head drive circuit 51 controls the thermal head 11 as a print means, on the basis of print pattern data, thereby to perform printing on the tape member 31 as a medium to be printed. The step motor drive circuit 52 is a circuit that drives a conveying mechanism, and controls a step motor 46 that rotates the platen roller and ribbon take-up shaft to convey the tape member 31 in a longitudinal direction at a predetermined speed. The cutter motor drive circuit 53 is a drive circuit that controls a motor that drives the full-cut mechanism, half-cut mechanism and so on. That is, the cutter motor drive circuit 53 controls the cutter motor 48 used in the full-cut mechanism and half-cut mechanism.

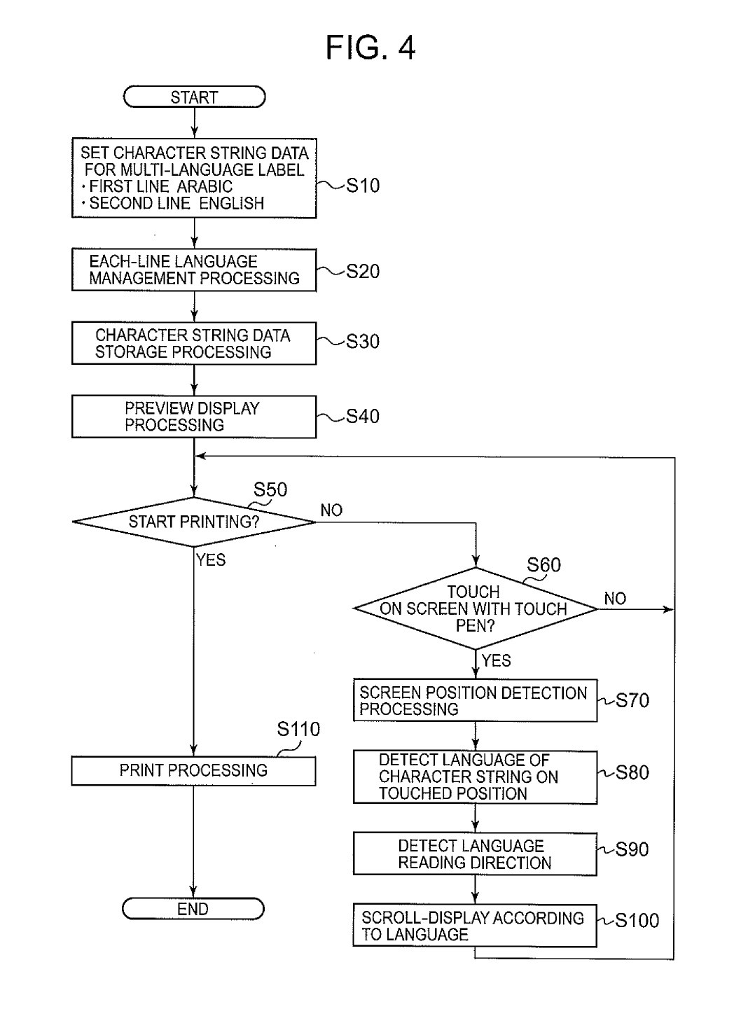

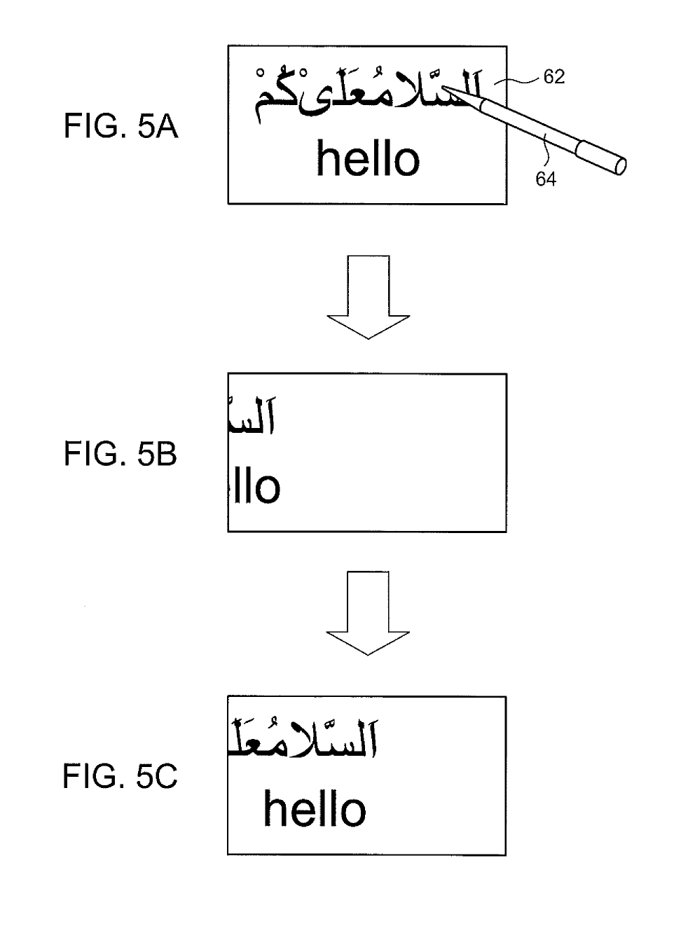

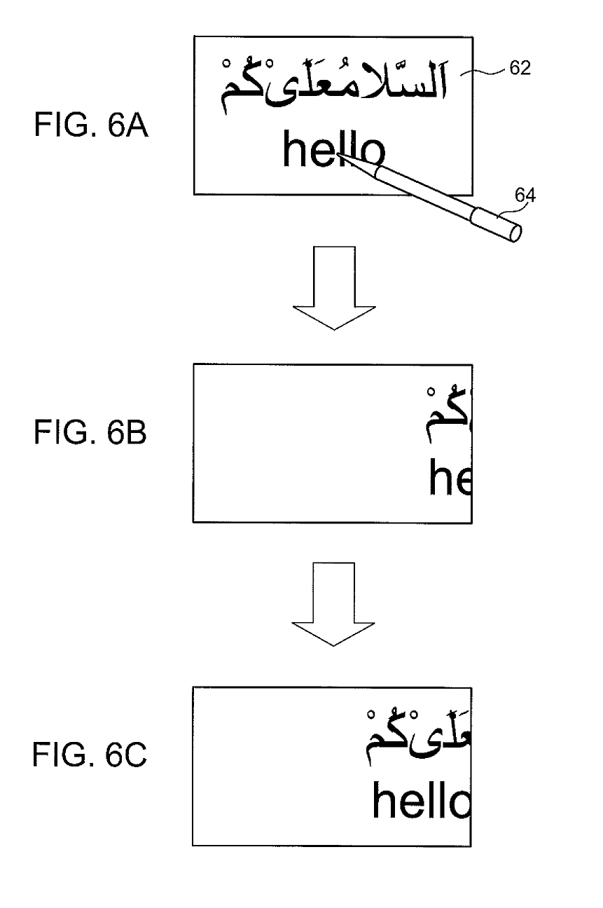

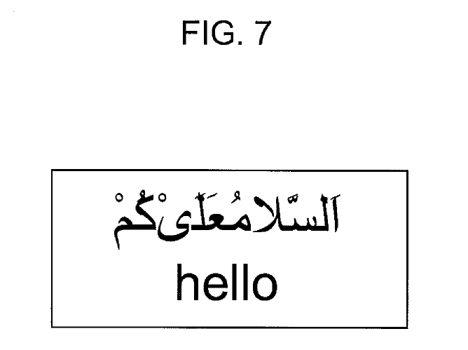

A flow chart of producing labels of a plurality of lines of character strings including display control in the print device 1 according to the present invention will be described in detail with reference to drawings. FIG. 4 is a flow chart illustrating the flow path of producing labels of a plurality of lines of character strings including display control in the print device 1. FIG. 5A, FIG. 5B and FIG. 5C are illustrations of scroll-display when Arabic on the first line is selected by a touch on the screen from a plurality of lines of character strings previewed. FIG. 6A, FIG. 6B and FIG. 6C are illustrations of scroll-display when English on the second line is selected by a touch on the screen from a plurality of lines of character strings previewed. FIG. 7 is an illustration of an example of a label composed of a plurality of lines of character strings that is produced by the print device 1.

First, when, as data for producing a multi-language label of a plurality of lines of character strings, the user sets characters representing “hello” in Arabic on the first line and “hello” in English on the second line as illustrated in FIG. 5A and FIG. 6A, the control section 40 performs processing to set character string data (Step S10).

The control section 40 performs language setting processing (Step S20) to make the RAM 42 as a language setting section store data indicating the first line is Arabic and the second line is English, as well as reading direction information of the respective languages, based on the set character string data. Languages for the respective lines may be set by user input.

Then, the control section 40 performs character string data storage processing (Step S30) to store character string data set by user operation for producing labels of a plurality of lines of character strings in the RAM 42 as a character string data storage means.

Next, the control section 40 not only stores character string data in the character string data storage section of the RAM 42, but also stores the character string data as pattern data in a display data memory for display on the touch panel display section 62, and performs preview display processing (Step S40) to control the touch panel display section drive circuit 61 as a display control means to display a preview screen on the touch panel display section 62.

The preview display is displayed as with the character layout of the label to be produced. In the preview display according to the embodiment, the character string of each line is displayed in center alignment, as illustrated in FIG. 5A and FIG. 6A.

Next, while displaying the preview on the touch panel display section 62, the control section 40 performs a print start determination (Step S50) to determine whether or not the user presses the print key to instruct print start.

In the print start determination (Step S50), if it is determined that the user pressed the print key to instruct print start, processing proceeds to print processing (Step S110). The control section 40, as a print data generation means, performs print data generation processing to generate print pattern data, on the basis of character string data stored in the character string data storage section of the RAM 42, and then on the basis of the generated print pattern data the control section 40 performs print processing (Step S110) to control the print section to print a plurality of lines of character strings on a medium thereby producing a label.

In print processing (Step S110), the control section 40 performs print in the same character layout as that in the preview screen illustrated in FIG. 5A and FIG. 6A, thereby producing the label as illustrated in FIG. 7.

In the above print start determination (Step S50), if it is determined that the user did not start the print key to instruct print start, processing proceeds to screen touch determination (Step S60) to determine whether the touch panel display section 62 was touched or not.

In the screen touch determination (Step S60), if it is determined that the user touched the touch panel display section 62, processing proceeds to screen position detection processing (Step S70). If it is determined that the user did not touch the touch panel display section 62, processing returns to print start determination (Step S50).

If it is determined that the user touched the touch panel display section 62, the control section 40 as a character string specifying means detects coordinate data corresponding to the touched screen position in screen position detection processing (Step S70).

After the control section 40 detects coordinate data, the control section 40 detects which line of a previewed label of a plurality of lines of character strings the detected coordinate data corresponds to. After the control section 40 detects which line the coordinate data corresponds to, the control section 40 performs language detection processing (Step S80) to detect the language of the touched screen position, based on data indicating the first line is Arabic and the second line is English that was stored in the language setting section of the RAM 42 in each-line language management processing (Step S20) for language setting.

In language detection processing (Step S80), for example, if the character string on the first line is touched as illustrated in FIG. 5A, the control section 40 as a reading direction determination section determines the touched language is Arabic and its reading direction is from right to left, based on data stored in the language setting section of the RAM 42. The control section 40 determines that Arabic has been selected, and, as a direction control means, performs scroll direction control processing (Step S90) to scroll-display in a left-to-right direction.

In order to scroll-display in a left to right direction in scroll direction control processing (Step S90), the control section 40 performs display control processing (Step S100) to place respective lines of character string data in right alignment as illustrated in FIG. 5B and FIG. 5C, and scroll-display in a left to right direction.

For example, if the character string on the second line is touched as illustrated in FIG. 6A, the control section 40 determines that the selected language is English, based on data stored in the language setting section of the RAM 42 in language detection processing (Step S80). Then, the control section 40 determines that English has been selected and its reading direction is from left to right, and as a direction control means, performs scroll direction control processing (Step S90) to scroll-display in a right to left direction. Then, in order to scroll-display in a right to left direction in scroll direction control processing (Step S90), the control section 40 performs display control processing (Step S100) to place respective lines of character string data as illustrated FIG. 6B and FIG. 6C in left alignment, and scroll-display in a right to left direction.

By performing display control processing (Step S100), while scroll-display is being performed in a predetermined direction according to the selected language, processing returns to print start determination (Step S50).

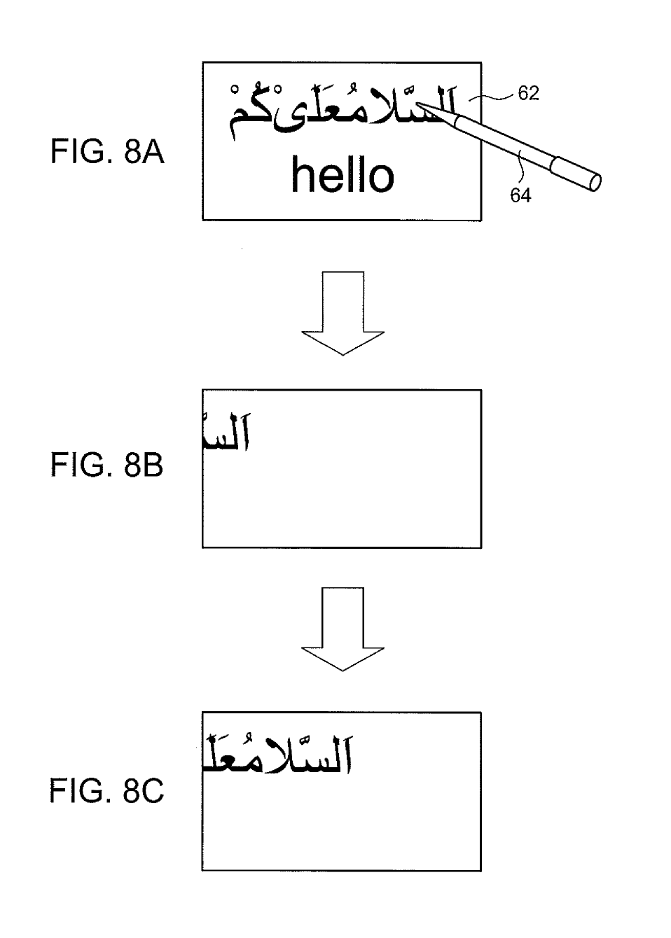

A method to scroll-display in a predetermined direction according to the selected language by performing display control processing (Step S100) is not limited to the above. By selecting Arabic on the first line during preview display as illustrated in FIG. 8A, only the Arabic character string on the first line is scroll-displayed in a left to right direction that is a predetermined direction as illustrated in FIG. 8B and FIG. 8C. That is, only character string data of the selected language may be scroll-displayed.

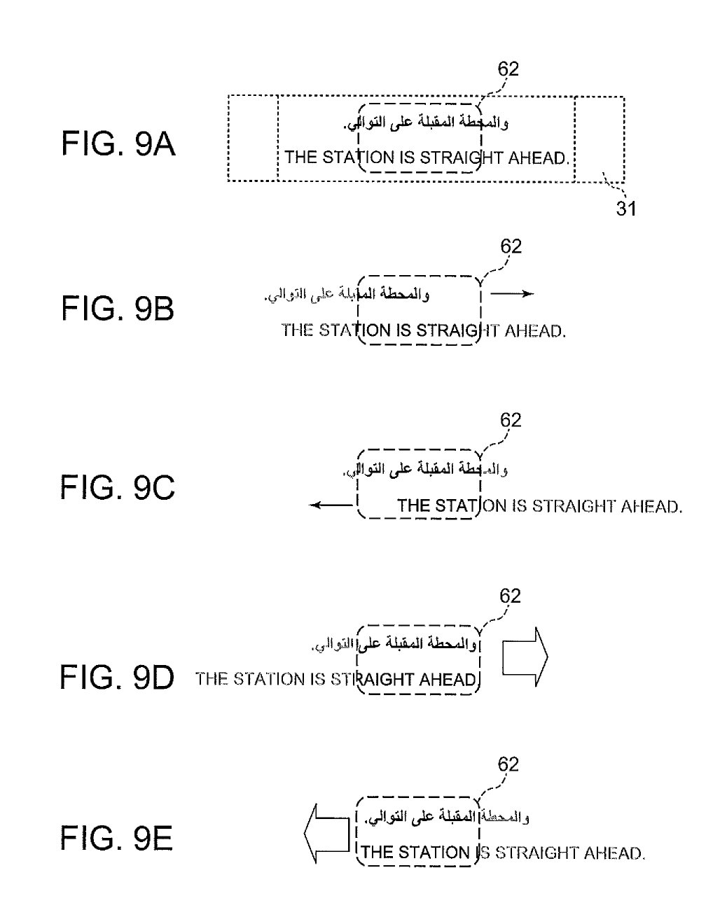

FIG. 9A is an illustration of another example of producing labels of a plurality of lines of character strings that is produced by the print device 1.

This example illustrates the embodiment in which a label reading the guide sign of “the station is straight ahead” in Arabic on the first line and in English on the second line is produced.

In this example, in order to produce this label, an Arabic sentence and an English sentence having the same meaning are inputted on the first line and second line, respectively, with the use of the keyboard input section 3, or inputted character string information is translated by the translation processing section 43; and after that, the inputted or translated result is checked using preview display. As a display form for the preview display, FIG. 9B illustrates an example in which when the first line is touched, only the first line is scroll-displayed independently in the reading direction of Arabic; and FIG. 9C illustrates an example in which when the second line is touched, only the second line is scroll-displayed independently in the reading direction of English. FIG. 9D illustrates an example in which when the first line is touched, an entire screen is scroll-displayed in the reading direction of Arabic on the first line; and FIG. 9E illustrates an example in which when the second line is touched, an entire screen is scroll-displayed in the reading direction of English on the second line.

As described above, an embodiment of the present invention can provide an electronic device that, by selecting a character string displayed in the preview screen, recognizes the reading direction of the language of the selected character string, scroll-displays character information in a predetermined direction according to its language, and has a function of printing multi-language character strings simultaneously to produce printed material; a display method to scroll-display character information in a predetermined direction according to its language in the electronic device; and a storage medium to make the electronic device realize the display method to scroll-display character information in a predetermined direction according to its language.

According to an embodiment of the present invention, in producing a multi-language label, since character layout can be previously checked in the preview screen, it can be checked whether or not character positions are suitable and so on before printing.

Furthermore, according to an embodiment of the present invention, the touch panel as a screen position detection means makes input operation such as character selection easier.

An embodiment of the present invention can also provide an electronic device that can deal with Japanese and English, as well as Arabic since the display control section scroll-displays all of a plurality of lines of character string data in a predetermined direction according to the language detected by the screen position selected by inputting with a touch on the screen.

Furthermore, according to an embodiment of the present invention, the display control section scroll-displays only character string data of the language detected in a predetermined direction according to the language detected from the screen position selected by inputting with a touch on the screen. Therefore, if an Arabic character string, for example, is selected, character changes can be previously checked, including that each Arabic character form changes depending on its position within a word such as the beginning, middle or end of the word and that if a certain character comes subsequent to a certain character, they are changed to one particular character.

Furthermore, processing illustrated in the flow chart according to an embodiment of the present invention, as a display control program realized in a computer, can be applied to various devices in such a way that the processing is written on a storage medium such as a magnetic disk, an optical disk and a semiconductor memory, or is conveyed by a communication medium. In this way, each processing of the present embodiment is stored in a desired storage medium, and the display control program is executed in another computer, thereby exhibiting the same effect as that obtained by using the device of the present embodiment. The computer is not limited to the computer embedded in the device described in the present embodiment, but includes any computer that can read the display control program stored in the storage medium and is provided with an arithmetic and logical unit such as a CPU that performs control operation according to the read display control program.

Although one embodiment of the present invention has been described, the scope of the present invention is not limited to this embodiment. That is, respective elements of this embodiment may be substituted with their equivalents by a person skilled in the art, which are also within the scope of the present invention. In the present embodiment, the electronic device 1 has been described, taking Japanese, English, Chinese, Korean, Arabic, Hebrew and Persian as languages to be used, as an example. However, by enabling other languages such as French, German, Portuguese, Spanish and Italian to be used, a more convenient electronic device 1 can be provided.

The present invention can be realized by an electronic device having the same function and configuration as those of the electronic device of the above embodiment. By applying a program to an existing electronic device, the existing electronic device also can function as the print device according to the present invention. In this case, by making a computer (a control section such as a CPU) of the electronic device that has the same configuration as that of the print device, exemplified in the above embodiment, execute a program to realize the same function as that of the above electronic device, the electronic device having the same configuration can function as the electronic device according to the present invention. Any method for applying such a program can be employed. For example, the program can be applied in such a way that the program is stored in a storage medium such as a CD-ROM or a memory card, or can be applied through a communication medium such as the Internet.

Having described and illustrated the principles of this application by reference to one preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

What is claimed is:

1. An electronic device comprising:
a display section that displays a plurality of lines of character strings on a screen;
a character string specifying section that specifies one of the character strings displayed on the screen; and
a display control section that scroll-displays the one of the character strings specified by the character string specified section based on a reading direction of the one of the character strings.

2. The electronic device according to claim 1, comprising an input section that inputs character string data corresponding to the character string in response to key operation.

3. The electronic device according to claim 2, comprising a translation processing section that translates the character string data inputted by the input section, wherein the display control section displays the character string translated by the translation processing section on a different line from the inputted character string.

4. The electronic device according to claim 1, wherein the display control section performs scroll-display if at least one of the plurality of lines of character strings displayed does not fit into the screen.

5. The electronic device according to claim 1, further comprising a language identification section that identifies the language of the character string, wherein the display control section determines the reading direction of the character string specified by the character string specifying section according to the language identified by the language identification section.

6. The electronic device according to claim 1, wherein the display section comprises a touch panel, wherein the character string specifying section identifies a specified line based on a touch-input position on the touch panel.

7. The electronic device according to claim 2, comprising a print section that prints a plurality of lines of character strings on a print medium on the basis of character string data inputted by the input section, wherein the display section previews the plurality of lines of character strings to be printed by the print section.

8. The electronic device according to claim 1, wherein the display control section scroll-displays all of the plurality of lines of character strings displayed on the screen according to the reading direction of the character string specified by the character string specifying section.

9. The electronic device according to claim 1, wherein the display control section scroll-displays only the character string specified by the character string specifying section based on a reading direction of the character string, out of a plurality of lines of character strings displayed on the screen.

10. A display control method to perform:
display processing that displays a plurality of lines of character strings on a screen;
character string specifying processing that specifies one of the character string out of the plurality of character strings displayed on the screen; and
display control processing that scroll-displays the one of the character strings specified by the character string specifying section based on a reading direction of the one of the character strings.

11. The display control method according to claim 10, comprising performing input processing that inputs character string data corresponding to the character string in response to key operation.

12. The display control method according to claim 11, comprising performing translation processing that translates the character string data inputted by the input section, wherein the display control processing displays the character string translated by the translation processing on a different line from the inputted character string.

13. The display control method according to claim 10, wherein the display control processing performs scroll-display if at least one end of the plurality of lines of character strings displayed on the screen does not fit into the screen.

14. The display control method according to claim 10, further including language identification processing that identifies the language of the character string, wherein the display control processing determines the reading direction of the character string specified by the character string specifying processing, according to the language identified by the language identification section.

15. The display control method according to claim 10, wherein the display processing comprises a touch panel control processing that controls a touch panel which detects a touch-input operation on the screen and wherein the character string specifying processing identifies the specified character string based on a touch-input position on the touch panel.

16. The display control method according to claim 11, comprising a print processing that prints a plurality of lines of character strings on a print medium, on the basis of character string data inputted by the input processing, wherein the display processing previews the plurality of lines of character strings to be printed by the print processing.

17. The display control method according to claim 10, wherein the display control processing scroll-displays all of a plurality of lines of character strings displayed on the screen based on a reading direction of the character string specified by the character string specifying processing.

18. The display control method according to claim 10, wherein the display control processing scroll-displays only a character string specified by the character string specifying processing based on a reading direction of the character string, out of a plurality of lines of character strings displayed on the screen.

19. A non-transitory computer-readable storage medium with an executable display control program stored thereon, wherein the program instructs a computer to perform the following steps:
display processing that displays a plurality of lines of character strings on a screen;
character string specifying processing that specifies a character string, out of the plurality of character strings displayed on the screen; and
display control processing that scroll-displays the one of the character strings specified by the character string specifying section based on a reading direction of the one of the character strings.

20. The non-transitory computer-readable storage medium according to claim 19, making a computer perform input processing that inputs character string data corresponding to the character string in response to key operation.
